(19) United States
(12) Patent Application Publication
(10) Pub. No.: US 2007/0121255 A1
(43) Pub. Date: May 31, 2007

(54) Magneto-resistance effect element having Heusler alloy compounds adjacent to spacer layer

(75) Inventors: Yoshihiro Tsuchiya, Tokyo (JP); Tomohito Mizuno, Tokyo (JP); Koji Shimazawa, Tokyo (JP); Daisuke Miyauchi, Tokyo (JP)

Correspondence Address: FITCH, EVEN, TABIN & FLANNERY, P. O. BOX 18415, WASHINGTON, DC, 20036, US

(73) Assignee: TDK Corporation, Tokyo (JP)

(21) Appl. No.: 11/519,921

(22) Filed: Sep. 13, 2006

(30) Foreign Application Priority Data
Nov. 30, 2005 (JP) 2005-345777

(51) Int. Cl. G11B 5/33; G11B 5/127

(52) U.S. Cl. 360/324.1; 360/324.11; 360/324.12

(57) ABSTRACT

A magneto-resistance effect element according to the present invention comprises a pinned layer whose magnetization direction is fixed; a free layer whose magnetization direction varies in accordance with an external magnetic field; and a nonmagnetic spacer layer that is arranged between said pinned layer and said free layer. At least either said pinned layer or said free layer includes a Heusler alloy layer that is disposed adjacent to said spacer layer, and compounds are arranged in a dotted pattern at an interface between said spacer layer and at least said spacer layer and said pinned layer or said spacer layer and said free layer, said compounds including material that is included in said Heusler alloy layer.

The present application is based on, and claims priority from, J.P. Application No. 2005-345777, filed on November, 2005, the disclosure of which is hereby incorporated by reference herein in its entirety.

### BACKGROUND OF THE INVENTION

1. Field of the Invention

The present invention relates to a magneto-resistance effect element that is suitable for a hard disk drive.

2. Description of the Related Art

A thin film magnetic head having a magneto-resistance effect element (MR element) that reads a magnetic signal is used for a hard disk drive. Since higher recording density has been realized in a hard disk drive in recent years, the need for higher sensitivity and higher output has particularly increased for the magneto-resistance effect element of a thin film magnetic head.

In order to cope with such needs, a magneto-resistance effect element using a spin valve film (SV film) has been developed, which has a pinned layer whose magnetization direction is fixed, a free layer whose magnetization direction varies in accordance with an external magnetic field, and a nonmagnetic spacer layer that is arranged therebetween. The pinned layer and the free layer are formed as ferromagnetic layers. The pinned layer is arranged on an antiferromagnetic layer, which fixes the magnetization direction of the pinned layer. In recent years, a synthetic SV film has also been developed, which has, instead of a pinned layer of a single layer structure made of ferromagnetic material, a pinned layer of a three-layer structure consisting of a ferromagnetic layer, a nonmagnetic metal layer, and a ferromagnetic layer. In a synthetic SV film, an exchange coupling force that is exerted from the antiferromagnetic layer can be effectively enhanced because of the strong exchange coupling between the two ferromagnetic layers.

In order to achieve higher output, a magneto-resistance effect element of a CPP (Current Perpendicular to Plane) type has also been proposed, in which current flows perpendicular to layer surfaces. It is desirable that the ferromagnetic layer in a CPP-type magneto-resistance effect element has a large polarizability. If the polarizability is large, then a larger magneto-resistance ratio (MR ratio), which indicates the sensitivity of a magneto-resistance effect element, can be obtained. Japanese Patent Laid-Open Publication No. 2003-218428 discloses a magneto-resistance effect element in which at least either the pinned layer or the free layer has a ferromagnetic and half-metal-like alloy layer. In this patent document, a layer is disclosed that is made of full-Heusler alloy having the chemical formula X₂YZ (where X is an element that is selected from Group IIIA to Group IIB in the periodic table, Y is Mn, and Z is one or more elements that is selected from the group consisting of Al, Si, Ga, In, Sn, Tl, and Pb) as an example of the ferromagnetic and half-metal-like alloy layer.

In order to obtain a large polarizability in full-Heusler alloy, it is particularly important that the full-Heusler alloy has a specific crystal structure (the L21 structure or B2 structure). In order for the full-Heusler alloy to have the specific crystal structure, it is important that the composition ratio of elements X, Y, Z, which constitute the full-Heusler alloy, is approximately X:Y:Z=2:1:1.

However, it is not easy for an actual element in which the full-Heusler alloy is arranged on the spacer layer to have the above-mentioned crystal structure, because the composition ratio of the full-Heusler alloy changes due to diffusion between both layers. As a result, the polarizability of the pinned layer and the free layer is not increased as much as expected, and sufficient advantage of the full-Heusler alloy is not gained.

The object of the present invention is to provide a magneto-resistance effect element that uses a Heusler alloy layer for at least either the pinned layer or the free layer, and that is more apt to have a specific crystal structure in order to increase the magneto-resistance ratio, and to provide a method of manufacturing the same.

### SUMMARY OF THE INVENTION

It may be effective to dispose an oxide layer between the Heusler alloy layer and the spacer layer in order to prevent diffusion. However, providing such a layer alone will lead to larger electric resistance, and to a degraded high-frequency response in a CPP-type magneto-resistance effect element. The inventors studied a magneto-resistance effect element that has a large magneto-resistance ratio but without affecting electric characteristics, and invented the magneto-resistance effect element having the following structure.

A magneto-resistance effect element according to the present invention comprises a pinned layer whose magnetization direction is fixed; a free layer whose magnetization direction varies in accordance with an external magnetic field; and a nonmagnetic spacer layer that is arranged between said pinned layer and said free layer. At least either said pinned layer or said free layer includes a Heusler alloy layer that is disposed adjacent to said spacer layer, and compounds are arranged in a dotted pattern at an interface between at least said spacer layer and said pinned layer or said spacer layer and said free layer, said compounds including material that is included in said Heusler alloy layer.

In the magneto-resistance effect element of the present invention, diffusion between the spacer layer and the Heusler alloy layer is prevented, because compounds are formed at the interface between the spacer layer and the Heusler alloy layer that is arranged thereon. As a result, variation in the composition ratio of the Heusler alloy layer is prevented, leading to a high polarizability of the Heusler alloy layer, and to a large resultant MR ratio of the magneto-resistance effect element. Further, since the compounds are arranged in a dotted pattern, an increase in electric resistance of the magneto-resistance effect element, which may be caused by the compounds, is prevented, leading to an excellent high-frequency response.

The Heusler alloy layer may be made of full-Heusler alloy, said full-Heusler alloy being represented by a chemical formula X₂YZ, wherein X is at least one element that is selected from the group consisting of Co, Ir, Rh, Pt, and Cu, wherein Y is at least one element that is selected from the group consisting of V, Cr, Mn, and Fe, and wherein Z is at least one element that is selected from the group consisting of Al, Si, Ga, Sb, and Ge. The compound may be an oxide of Cr, Mn, Al, or Si.

The pinned layer may include a nonmagnetic intermediate layer, and two ferromagnetic layers that sandwich said nonmagnetic intermediate layer.

The ratio of a total area of said compounds to a total area of said interface is preferably less than 50%.

In another embodiment of the present invention, a method of manufacturing a magneto-resistance effect element is provided, in which a pinned layer whose magnetization direction is fixed, a nonmagnetic spacer layer, and a free layer whose magnetization direction varies in accordance with an external magnetic field are stacked in this order. The method comprises a step of forming a Heusler alloy layer in at least either said pinned layer or said free layer such that said Heusler alloy layer is disposed adjacent to said spacer layer; and a step of forming compounds in a dotted pattern at an interface between at least said spacer layer and one of said Heusler alloy layers, said compounds including material that is included in said Heusler alloy layer.

In yet another embodiment of the present invention, a thin film magnetic head comprising the magneto-resistance effect element mentioned above is provided.

According to the magneto-resistance effect element and the thin film magnetic head of the present invention, a large MR ratio can be achieved, while limiting an increase in electric resistance, by providing compounds at the interface between the Heusler alloy layer and the spacer layer in a dotted pattern. Further, according to the method of manufacturing the magneto-resistance effect element of the present invention, such a magneto-resistance effect element can be manufactured.

The above and other objects, features and advantages of the present invention will become apparent from the following description with reference to the accompanying drawings which illustrate examples of the present invention.

### BRIEF DESCRIPTION OF THE DRAWINGS

FIG. 1 is a cross-sectional view of the essential part of a thin film magnetic head according to an embodiment of the present invention;

FIG. 2 is a diagram of the MR element shown in FIG. 1, viewed from the side of the air bearing surface;

FIG. 3 is a schematic view showing the crystal structure of Heusler alloy having the. L21 structure;

FIGS. 4-5 are diagrams showing a MR element in other embodiments, viewed from the side of the air bearing surface;

FIG. 6 is a plan view of a wafer on which thin film magnetic heads shown in FIG. 1 are manufactured;

FIG. 7 is a perspective view illustrating a slider which includes a thin film magnetic head shown in FIG. 1;

FIG. 8 is a perspective view illustrating a head gimbal assembly which includes a slider shown in FIG. 7;

FIG. 9 is a side view illustrating the essential part of a hard disk drive which includes a head gimbal assembly shown in FIG. 8; and

FIG. 10 is a plan view of a hard disk drive which includes a head gimbal assembly shown in FIG. 8.

### DETAILED DESCRIPTION OF THE INVENTION

Next, explanations are given about embodiments of the present invention with reference to drawings.

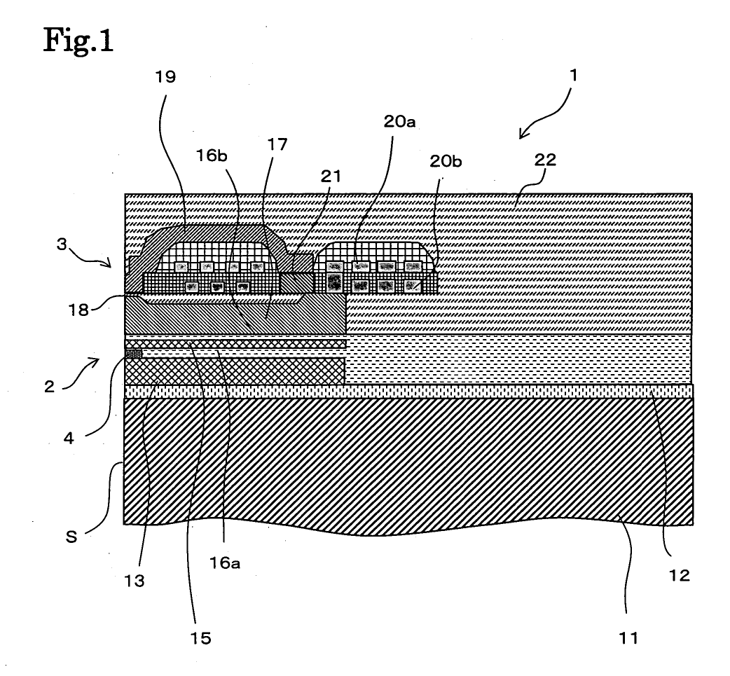

FIG. 1 is a conceptual cross-sectional view showing the essential part of a thin film magnetic head according to an embodiment of the present invention.

Thin film magnetic head 1 of the present embodiment has substrate 11, read head portion 2 for reading data from a storage medium, not shown, and write head portion 3 for writing data to the storage medium.

Substrate 11 is made of Al₂O₃.TiC (AlTiC) that is highly resistant against wear. Seed layer 12, made of alumina, is formed on the upper surface of substrate 11. Read head portion 2 and write head portion 3 are formed on seed layer 12.

Lower shield layer 13, made of magnetic material, such as perm-alloy (NiFe), is formed on seed layer 12. MR element 4 is formed on the end portion of lower shield layer 13 on the side of air bearing surface S, and the end of MR element 4 is exposed to air bearing surface S. First lower shield layer 15, made of magnetic material, such as perm-alloy, is formed on MR element 4. Lower shield layer 13, MR element 4, and first upper shield layer 15 constitute read head portion 2. The portion between lower shield layer 13 and first upper shield layer 15 is mainly filled with insulating layer 16a except for MR element 4.

Lower magnetic pole layer 17, made of magnetic material, such as perm-alloy or CoNiFe, is formed on first upper shield layer 15 via insulating layer 16b. Lower magnetic pole layer 17 functions as the lower magnetic pole layer for write head portion 3, and also functions as the upper shield layer for MR element 4.

Upper magnetic pole layer 19 is formed on second upper shield layer 17 via write gap layer 18. Write gap layer 18 is made of nonmagnetic material, such as Ru or alumina. Write gap layer 18 is formed such that one of the end portions thereof is exposed to air bearing surface S. Magnetic material, such as perm-alloy or CoNiFe, is used as the material of upper magnetic pole layer 19. Second upper shield layer (lower magnetic pole layer) 17 and upper magnetic pole layer 19 are magnetically coupled to each other via connecting portion 21 to form one magnetic circuit as a whole.

Coils 20a, 20b, made of conductive material, such as copper, are formed in two layers between second upper shield layer 17 and upper magnetic pole layer 19, and between air bearing surface S and connecting portion 21. Coils 20a, 20b, which supply magnetic flux to second upper shield layer 17 and upper magnetic pole layer 19, are wound around connecting portion 21 in a planar and helical shape. Coils 20a, 20b are insulated from the surroundings by the insulating layer. The arrangement of the coil is not limited to two-layer coils 20a, 20b shown in the present embodiment. One layer structure and structure in three or more layers are also possible.

Overcoat layer 22 is disposed over upper magnetic pole layer 19 to protect the above-mentioned structure. Insulating material, such as alumina, is used as the material for overcoat layer 22.

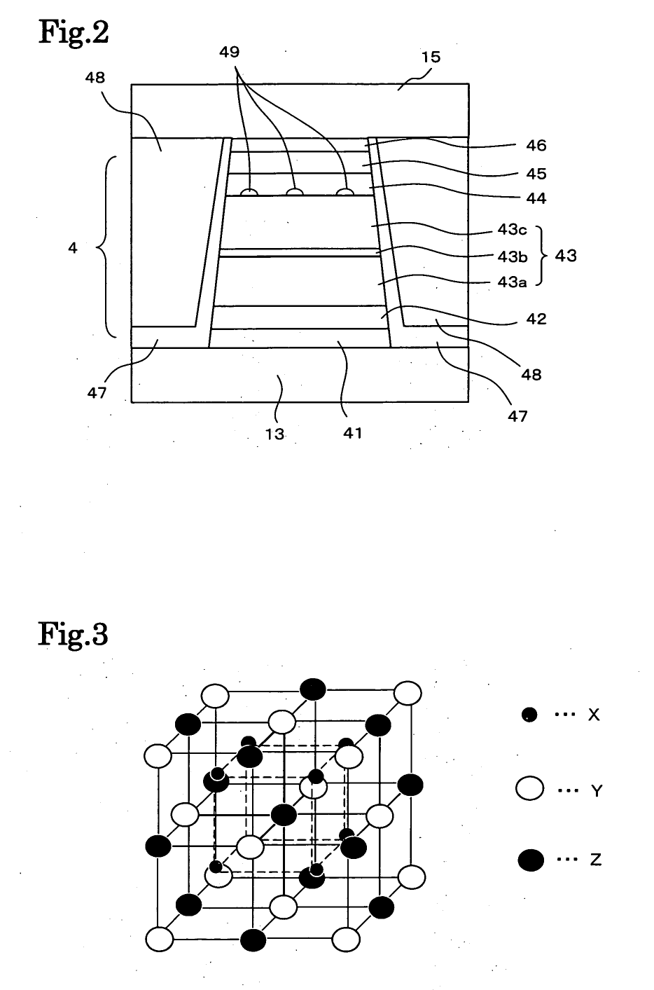

Next, detailed explanations are given about MR element 4 with reference to FIG. 2, which is a diagram of MR element 4 shown in FIG. 1 viewed from the side of air bearing surface S.

MR element 4 is arranged between lower shield layer 13 and upper shield layer 15, as described above, and has a structure in which buffer layer 41, antiferromagnetic layer 42, pinned layer 43, spacer layer 44, free layer 45, and cap layer 46 are stacked in this order on lower shield layer 13. In this exemplary arrangement, pinned layer 43 has a structure in which nonmagnetic intermediate layer 43b is arranged between outer layer 43a, made of ferromagnetic material, and inner layer 43c, made of ferromagnetic material. Pinned layer 43 having such a layer structure is called a synthetic pinned layer. Outer layer 43a is arranged adjacent to antiferromagnetic layer 42, and inner layer 43c is arranged adjacent to spacer layer 44.

Lower shield layer 13 and upper shield layer 15 also function as electrodes. Sense current flows through MR element 4 in the direction that is perpendicular to the layer surfaces via lower shield layer 13 and upper shield layer 15.

Buffer layer 41 has a combination of material, such as Ta/NiCr, Ta/Ru, and Ta/NiFe, that improves exchange coupling between antiferromagnetic layer 42 and outer layer 43a of pinned layer 43. Antiferromagnetic layer 42, which fixes the magnetization direction of pinned layer 43, is made of IrMn, PtMn, RuRnMn, NiMn, or the like.

Pinned layer 43, which is formed as a magnetic layer, has a structure in which outer layer 43a, nonmagnetic intermediate layer 43b, and inner layer 43 are stacked in this order, as described above. Outer layer 43a, whose magnetization direction is fixed relative to an external magnetic field by antiferromagnetic layer 42, is made of stacked layers, such as CoFe/FeCo/CoFe. Nonmagnetic intermediate layer 43b is made of, for example, Ru. Inner layer 43c has a layer that is made of Heusler alloy. Alternatively, inner layer 43c may be formed by stacking a Heusler alloy layer on a CoFe layer which is generally used for a ferromagnetic layer. In any layer structures, the Heusler alloy layer is arranged adjacent to spacer layer 44. In a synthetic pinned layer, since the magnetic moments of outer layer 43a and inner layer 43c are mutually canceled, the total leakage of magnetic field is limited. Also, the magnetization direction of inner layer 43c is securely fixed.

The Heusler alloy used in the present embodiment is a full-Heusler alloy represented by the chemical formula X₂YZ. In this formula, X is at least one element that is selected from the group consisting of Co, Ir, Rh, Pt and Cu. Y is at least one element that is selected from the group consisting of V, Cr, Mn, and Fe. Z is at least one element that is selected from the group consisting of Al, Si, Ga, Sb, and Ge. Specifically, chemical compositions such as Co₂MnSi, CO₂MnAl, Co₂(Cr_{0.6}Fe_{0.4})Al are used for the Heusler alloy. The Heusler alloy has a crystal structure shown in FIG. 3 (the L21 structure) or the B2 structure, not shown, and exhibits a large polarizability in these crystal structures. The Heusler alloy does not have the L21 structure or the B2 structure when the layer is deposited, but will have the L21 structure or the B2 structure after heat treatment, such as annealing.

Spacer layer 44 is made of nonmagnetic material, such as Au, Ag, Cr, and is preferably made of Cu.

The magnetization direction of free layer 45 varies in accordance with an external magnetic field. Magnetic material, such as CoFe or NiFe, may be used for free layer 45. Free layer 45 may have a multi-layered structure. In this case, a layer made of CoFe or the like may be disposed on the side of spacer layer 44.

Cap layer 46, which prevents deterioration of MR element 4, is made of, for example, Ru.

Hard bias films 48 are arranged on both sides of MR element 4 relative to the track width direction (the in-plane direction of each layer in MR element 4 in the plane parallel to air bearing surface S (see FIG. 1)) via insulating films 47. Hard bias films 48 put free layer 45 in a single magnetic domain state by applying a bias magnetic field to free layer 45 in the track width direction. Hard magnetic material, such as CoPt or CoCrPt, may be used for hard bias films 48. Insulating films 47, which prevent sense current from leaking to hard bias films 48, may be made by an oxide, such as Al₂O₃.

Now, the most characteristic feature of the present embodiment is explained. The most characteristic feature is that compounds 49 are disposed at the interface between inner layer 43c of pinned layer 43 and spacer layer 44. Compounds 49 are formed not in a continuous film, but in a dotted pattern on inner layer 43c. Since inner layer 43c includes a Heusler alloy layer on the side of spacer layer 44, compounds 49 are formed on the Heusler alloy layer. Compounds 49 include at least one element that is included in the Heusler alloy, and are preferably made of an oxide or a nitride of the element. Compound 49 that is made of an oxide preferably includes an element that is more apt to be oxidized, such as AlOₓ, SiOₓ, MnOₓ, than the other elements that constitute the Heusler alloy. If the Heusler alloy includes Fe or Cr, then FeOₓ or CrOₓ may be used for compounds 49.

As described above, compounds 49 are disposed between the Heusler alloy layer and spacer layer 44, and compounds 49 include at least one element, or more preferably an oxide or a nitride thereof, that constitutes the Heusler alloy layer. Thus, diffusion between the Heusler alloy layer and spacer layer 44 is prevented, and the composition ratio of the Heusler alloy that is represented by the chemical formula X₂YZ is kept at approximately X:Y:Z=2:1:1. As a result, most parts of the Heusler alloy have the L21 structure, and a large polarizability can be achieved. In this way, the advantage of the Heusler alloy can be effectively utilized and a large MR ratio can be achieved.

Further, since compounds 49 are formed not in a continuous film, but in a dotted pattern, the increase in resistance-area RA that is caused by compounds 49 is minimized at the interface between the Heusler alloy layer and spacer layer 44. If compounds 49 were formed in a continuous film, then resistance-area RA would increase at the interface between the Heusler alloy layer and spacer layer 44, and the sense current would be reduced, leading to degradation in high frequency response.

In the above embodiment, a synthetic pinned layer is used as pinned layer 43. However, pinned layer 43 may only consist of ferromagnetic material. In this embodiment, the entire pinned layer may be made of the Heusler alloy, or the pinned layer may be a stacked structure consisting of the Heusler alloy layer and another ferromagnetic layer, as long as the Heusler alloy layer is formed adjacent to spacer layer 44.

It is preferable that the ratio of the total area of compounds 49 to the total area of the interface between the Heusler alloy layer and spacer 44 is as large as possible in order to prevent diffusion. On the other hand, it is preferable that the ratio is as small as possible in order to limit the increase in resistance-area RA. Taking both aspects into account, the ratio of the total area of compounds 49 to the total area of the interface between the Heusler alloy layer and spacer 44 is preferably less than 50%.

MR element 4 which is described above can be manufactured according to the following method.

Buffer layer 41, antiferromagnetic layer 42, outer layer 43a, nonmagnetic intermediate layer 43b, and inner layer 43c are sequentially formed on lower shield layer 13. Next, compounds 49 are formed on inner layer 43c. Then, spacer layer 44, free layer 45, and cap layer 46 are sequentially formed on compounds 49. After cap layer 46 is formed, an annealing process is performed so that the Heusler alloy layer, which is included in inner layer 43c, is formed into L21 structure. A depositing process, such as sputtering, that is used to manufacture a conventional MR element can be utilized, except when forming compounds 49.

It is important that compounds 49 are formed in a dotted pattern, and the following method can be preferably used in order to form such a pattern.

According to the first method, the layers up to the Heusler alloy layer, on which compounds 49 are deposited, are formed using a conventional method. Next, raw material for compounds 49 is deposited on the Heusler alloy layer, and the raw material that has been deposited is oxidized or nitrided into compounds 49.

The raw material is made of an element that is included in the Heusler alloy layer and that is more apt to be oxidized or nitrided than the other elements, depending on the subsequent process, i.e., depending on which of the oxidizing process or the nitriding process is performed. The raw material can be deposited using a typical depositing process, such as sputtering, which is used to form other layers. The raw material is formed in a dotted pattern by forming the raw material in an equivalent film thickness in which a continuous film is not formed. The equivalent film thickness, which is calculated from deposition rate, is, for example, about 0.1 to 0.14 nm.

The oxidizing process or the nitriding process after the deposition of the raw material may be performed by exposing the surface of the raw material that has been deposited to oxidizing or nitriding atmosphere. The pressure of the atmosphere at which the surface of the raw material will be exposed is preferably 6.7 mPa to 133 mPa, and the exposure time is preferably 1 to 30 sec.

Alternatively, compounds 40 can be formed in a dotted pattern by oxidizing or by nitriding, not the entire film, but a part of the continuous film in the subsequent oxidizing or nitriding process. In this process, a layer that partially contains compounds 40 is formed between the Heusler alloy layer and spacer layer 44. However, the inventors think that atoms of the raw materials, in the region in which compounds 40 are not formed, flocculate to the region in which compounds 40 are formed in a dotted pattern during oxidization, and that few or no atoms of the raw materials remain in the region in which compounds 40 are not formed. Therefore it is thought that the influence on resistance-area RA is quite limited.

According to the second method, first, the Heusler alloy layer, which contains an element that is easily oxidized or nitrided and that has a composition ratio that is larger than the stoichiometric composition, is formed. Compounds 49 are formed by oxidizing or nitriding a part of the surface of the Heusler alloy layer. In this method, the element that is contained at a composition ratio larger than the stoichiometric composition is oxidized or nitrided, and as a result, the Heusler alloy layer that has been deposited is formed into a nearly stoichiometric composition through the oxidizing or nitriding process. Therefore, the Heusler alloy layer is successfully formed into the L21 structure after the subsequent heat treatment.

After the Heusler alloy layer has been deposited, the oxidizing process or nitriding process may be performed by exposing the surface of the Heusler alloy layer that is deposited to an oxidizing or nitriding atmosphere. The pressure of the atmosphere at which the surface of the raw material will be exposed is preferably 6.7 mPa to 133 mPa, and the exposure time is preferably 1 to 30 sec.

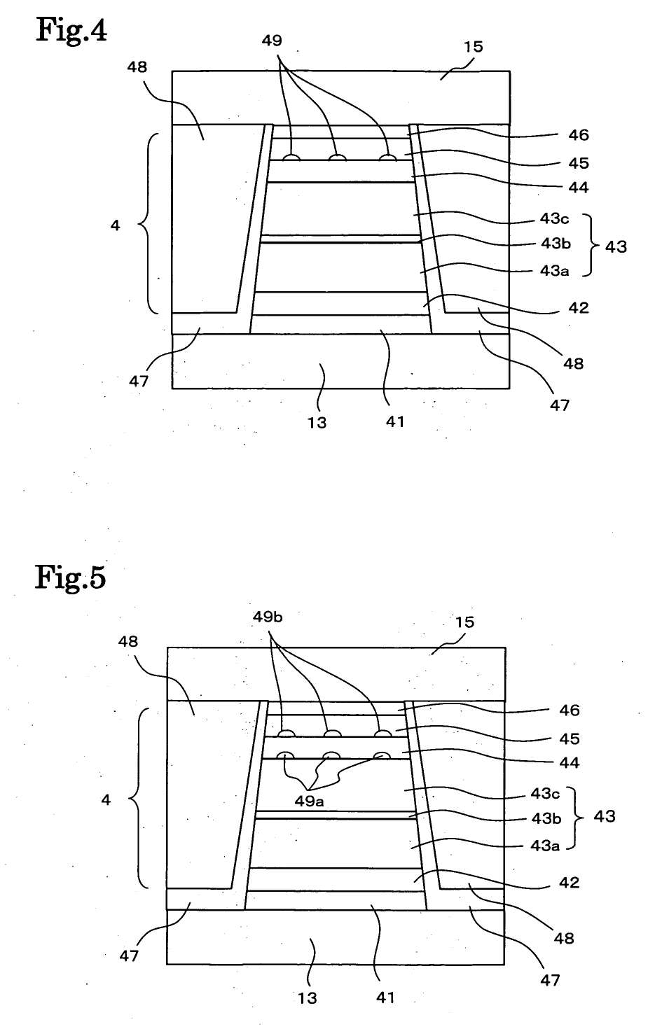

Next, another embodiment of the MR element is explained with reference to FIG. 4.

In the above-described embodiment, at least a part of inner layer 43c which is positioned adjacent to spacer layer 44 is made of a Heusler alloy layer, and compounds 49 are arranged at the interface between inner layer 43c and spacer layer 44. In MR element 4 shown in FIG. 4, the portion of free layer 45 which is positioned adjacent to spacer layer 44 is also made of a Heusler alloy layer, and compounds 49 are arranged, not at the interface between inner layer 43c and spacer 44, but at the interface between spacer layer 44 and free layer 45. Since the other features are similar to the embodiment shown in FIG. 2, the same reference numerals are given to the same parts in FIG. 4 and explanations thereof are omitted.

Free layer 45 may be entirely made of Heusler alloy, or may have a stacked structure consisting of Heusler alloy and another magnetic material, such as NiFe or CoFe. If free layer 45 has a stacked structure, then the portion that is positioned adjacent to spacer 44 is made of Heusler alloy. The Heusler alloy has the L21 structure. The Heusler alloy, similar to the above-mentioned embodiment, is full-Heusler alloy represented by the chemical formula X₂YZ (where X is at least one element that is selected from the group consisting of Co, Ir, Rh, Pt, and Cu, Y is at least one element that is selected from the group consisting of V, Cr, Mn, and Fe, and Z is at least one element that is selected from the group consisting of Al, Si, Ga, Sb, and Ge). Compounds 49, similar to the above-mentioned embodiment, also include at least one element that is included in Heusler alloy, and are arranged in a dotted pattern.

In this way, the same effects can be obtained as in the above-mentioned embodiment by providing a layer that is made of Heusler alloy in free layer 45. Specifically, a large polarizability, which is obtained by the L21 structure of the Heusler alloy, and a resultant large MR ratio can be achieved, while limiting an increase in resistance-area RA. Additionally, inner layer 43c does not need to include the Heusler alloy layer, although it is included in inner layer 43c in this embodiment. In other words, only free layer 45 may include the Heusler alloy layer.

Compounds 49 of the present embodiment can be formed mainly by the following two methods.

According to the first method, the layers up to spacer layer 44, on which compounds 49 are deposited, are formed using a conventional method. Next, raw material of compounds 49 is deposited on spacer layer 44, and the raw material that has been deposited is oxidized or nitrided into compounds 49.

The material is made of an element that is included in the Heusler alloy, which is deposited as a part or the entire part of free layer 45 after compounds 49 have been formed, and that is more apt to be oxidized or nitrided than the other elements, depending on the subsequent process, i.e., depending on which of the oxidizing process or the nitriding process is performed. The method of depositing the raw material and the method of oxidizing or nitriding the deposited raw material are similar to the method used in the above-mentioned embodiment, and therefore, explanations thereof are omitted. Heat treatment for forming the Heusler alloy layer into the L21 structure is performed after each layer in MR element 4 is deposited.

According to the second method, oxygen or nitrogen is adsorbed by spacer layer 44 to the surface thereof after spacer layer 44 is formed. After that, a Heusler alloy layer is formed as a part or the entire part of free layer 45 on spacer layer 44 which has adsorbed oxygen or nitrogen. Compounds 49 are formed by oxidizing or nitriding a part of the elements that are included in the Heusler alloy layer.

The adsorption of oxygen or nitrogen to the surface of spacer 44 may be performed by exposing the surface of spacer layer 44 to an oxidizing or nitriding atmosphere such that the entire surface of spacer 44 is not oxidized or nitrided. The pressure of the atmosphere at which the surface of the raw material will be exposed is preferably 6.7 mPa to 133 mPa, and the exposure time is preferably 1 to 30 sec.

In this way, a part of the element that is included in the Heusler alloy layer is oxidized or nitrided by making spacer layer 44 adsorb oxygen or nitrogen to the surface of spacer layer 44, and by forming the Heusler alloy layer on spacer layer 44. Oxide or nitride that is obtained by this process is formed at the interface between spacer layer 44 and the Heusler alloy layer as compounds 49.

Since a part of the element that is included in the Heusler alloy layer is used to form compounds 49, the Heusler alloy deviates from the stoichiometric composition, and the L21 structure can not be obtained after the subsequent heat treatment. Therefore, the Heusler alloy layer is formed such that the element of the Heusler alloy layer that is apt to be oxidized or nitrided has a composition ratio that is larger than the stoichiometric composition. This allows the Heusler alloy layer to have a nearly stoichiometric composition when compounds 49 are formed, and to successfully have the L21 structure after the subsequent heat treatment. Heat treatment for forming the Heusler alloy layer into the L21 structure is performed after each layer that constitutes MR element 4 is deposited.

The two typical MR elements of the present invention mentioned above may also be combined together.

FIG. 5 shows another embodiment of the MR element. In MR element 4 that is shown in FIG. 5, at least a part of inner layer 43c that is positioned adjacent to spacer layer 44 and at least a part of free layer 45 that is positioned adjacent to spacer layer 44 are made of Heusler alloy layers. In other words, both sides of spacer layer 44 are adjacent to Heusler alloy layers. The Heusler alloy included in inner layer 43c and the Heusler alloy included in free layer 4 may be made of the same elements or made of different elements, as long as the Heusler alloy is represented by the chemical formula X₂YZ (where X is at least one element that is selected from the group consisting of Co, Ir, Rh, Pt, and Cu, Y is at least one element that is selected from the group consisting of V, Cr, Mn, and Fe, and Z is at least one element that is selected from the group consisting of Al, Si, Ga, Sb, and Ge).

Compounds 49a are formed at the interface between inner layer 43c and spacer 44, and compounds 49b are formed at the interface between spacer layer 44 and free layer 45. These compounds 49a, 49b include at least one element that is included in the respective Heusler alloy layers on which compounds. 49a, 49b are formed, and are arranged in a dotted pattern, as explained in the above embodiments. Compounds 49a, 49b may be formed by a method that is similar to the above-mentioned methods, i.e., by an appropriate combination of the above-mentioned methods. Since the other features are similar to the embodiment shown in FIG. 2, the same reference numerals are given to the same parts in FIG. 5 and explanations thereof are omitted.

In the above-mentioned embodiments, the full-Heusler alloy, as represented by the chemical formula X₂YZ, was explained as an example of the Heusler alloy. Alternatively, a half-Heusler alloy represented by the chemical formula XYZ (where X is at least one element that is selected from the group consisting of Co, Ir, Rh, Pt, and Cu, Y is at least one element that is selected from the group consisting of V, Cr, Mn, and Fe, and Z is at least one element that is selected from the group consisting of Al, Si, Ga, Sb, and Ge) may be used, and the same effects is obtained.

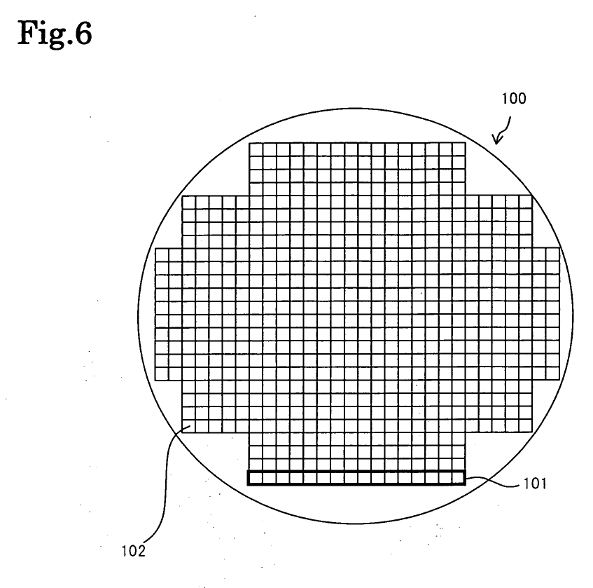

The thin-film magnetic heads according to the present invention are formed on a wafer. FIG. 6 is a schematic plan view of a wafer on which a plurality of thin-film magnetic heads shown in FIG. 1 are formed.

Wafer 100 has a plurality of head elements 102. Wafer 100 is diced into bars 101, in which a plurality of head elements 102 are formed in a row. Bar 101 serves as a work unit in the process of forming ABS. Bar 101 is diced into sliders each having a thin-film magnetic head after polishing. Spacing, not shown, is provided between head elements 102 in wafer 100 to dice wafer 100 into bars 101 and into sliders.

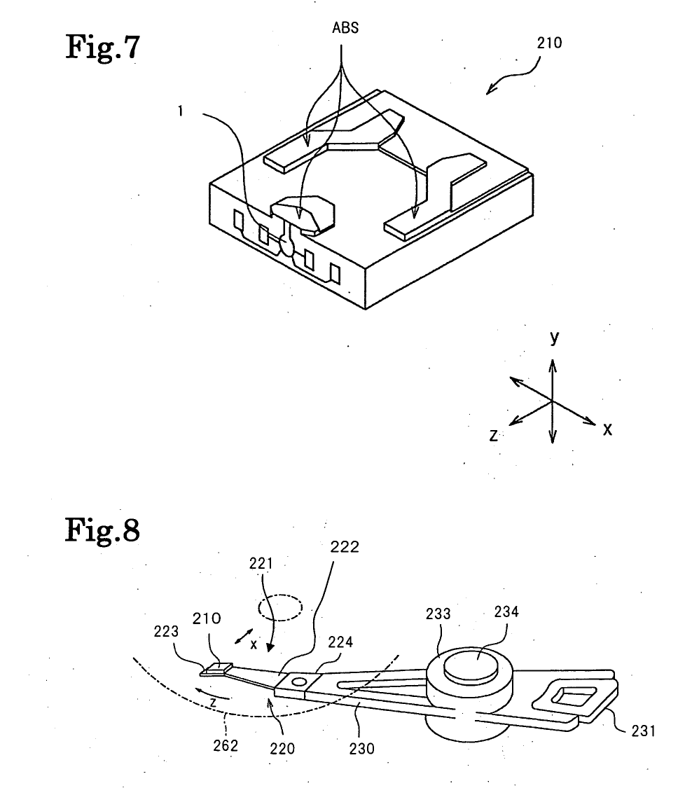

Explanation next regards a head gimbal assembly and a hard disk drive that use the thin-film magnetic head. Referring to FIG. 7, slider 210, which is included in the head gimbal assembly, will be described first. In a hard disk drive, slider 210 is arranged opposite to a hard disk, which is a rotationally-driven disciform storage medium. Slider 210 has a substantially hexahedral form. One of the six surfaces of slider 210 forms ABS, which is positioned opposite to the hard disk. When the hard disk rotates in the z direction shown in FIG. 7, an airflow which passes between the hard disk and slider 210 creates a dynamic lift which is applied to slider 210 downward in the y direction of FIG. 7. Slider 210 is configured to lift up from the surface of the hard disk with this dynamic lift effect. In proximity to the trailing edge (the end portion at the lower left in FIG. 7) of slider 210, which is on the outlet side of the airflow, thin-film magnetic head 1 is formed.

Referring to FIG. 8, head gimbal assembly 220 that has a thin-film magnetic head will be explained next. Head gimbal assembly 220 is provided with slider 210, and suspension 221 for elastically supporting slider 210. Suspension 221 has load beam 222 that is in the shape of a flat spring and is made of, for example, stainless steel. Suspension 221 also has flexure 223 that is attached to one end of load beam 222, and to which slider 210 is fixed, while providing an appropriate degree of freedom to slider 210. Suspension 221 further has base plate 224 that is provided on the other end of load beam 222. The portion of flexure 223 to which slider 210 is attached has a gimbal section for maintaining slider 210 in a fixed orientation.

The arrangement in which a head gimbal assembly 220 is attached to a single arm 230 is called a head arm assembly. Arm 230 moves slider 210 in the transverse direction x with regard to the track of hard disk 262. One end of arm 230 is attached to base plate 224. Coil 231, which constitutes a part of the voice coil motor, is attached to the other end of arm 230. In the intermediate portion of arm 230, bearing section 233 which has shaft 234 to rotatably hold arm 230 is provided. Arm 230 and the voice coil motor to drive arm 230 constitute an actuator.

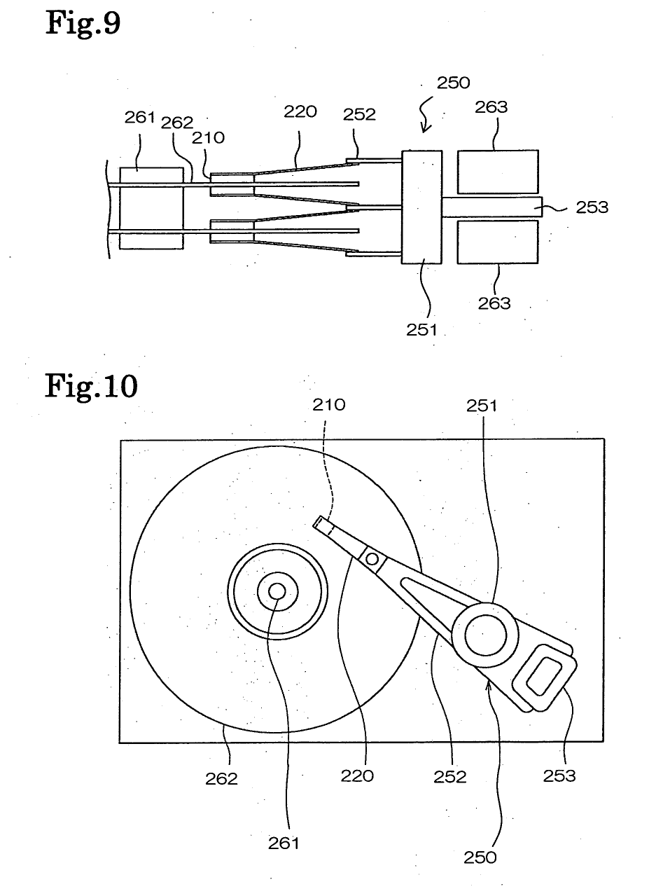

Referring to FIG. 9 and FIG. 10, a head stack assembly and a hard disk drive that use the thin-film magnetic head as a head element will be explained next. The arrangement in which head gimbal assemblies 220 are attached to the respective arms of a carriage having a plurality of arms is called a head stack assembly. FIG. 9 is an explanatory diagram illustrating an essential part of a hard disk drive, and FIG. 10 is a plan view of the hard disk drive. Head stack assembly 250 has carriage 251 provided with a plurality of arms 252. A plurality of head gimbal assemblies 220 are attached to a plurality of arms 252 such that head gimbal assemblies 220 are arranged apart from each other in the vertical direction. Coil 253, which constitutes a part of the voice coil, is attached to carriage 251 on the side that is opposite to arms 252. The voice coil motor has permanent magnets 263 which are arranged in positions opposite to each other interposing coil 253 of head stack assembly 250 therebetween.

Referring to FIG. 10, head stack assembly 250 is installed in the hard disk drive. The hard disk drive has a plurality of hard disks which are connected to spindle motor 261. Two sliders 210 are arranged per each hard disk 262 at positions opposite to each other interposing hard disk 262 therebetween. Head stack assembly 250 and the actuator, except for sliders 210, work as a positioning device. They carry sliders 210 and work to position sliders 210 relative to hard disks 262. Sliders 210 are moved by the actuator in the transverse direction with regard to the tracks of hard disks 262, and positioned relative to hard disks 262. Thin-film magnetic head 1 that is contained in slider 210 records information to hard disk 262 with a write head, and reads information recorded in hard disk 262 with a read head.

The thin film magnetic head is not limited to the above-mentioned embodiments, and various changes and modifications may be made. For example, in the above-mentioned embodiments, explanations were given about the thin film magnetic head in which a MR element for reading is formed on the side of the substrate, and an inductive magneto-electric transducer for writing is arranged above the MR element. However, the MR element and the magneto-electric transducer may be stacked in the reverse order. Further, in the above-mentioned embodiments, both the MR element and the inductive magneto-electric transducer are provided. However, the thin film magnetic head may only be provided with a MR element.

Next, specific examples of the present invention are explained together with comparative examples.

### EXAMPLE 1

In Example 1, the MR element shown in FIG. 2 was manufactured. Table 1 shows the layer structure and the thickness of each layer.

TABLE 1

| | | Material | Thickness (nm) |
|---|---|---|---|
| Cap layer | | Ru | 10 |
| Free layer | | CoFe/NiFe | 1/2 |
| Spacer layer | | Cu | 3 |
| Compounds | | (oxide) | — |
| Pinned layer | Inner layer | CoFe/Heusler alloy | 1/3 |
| | Intermediate layer | Ru | 0.8 |
| | Outer layer | CoFe/FeCo/CoFe | 0.5/0.5/1 |

| | | |
|---|---|---|
| Antiferromagnetic layer | IrMn | 7 |
| Buffer layer | Ta/NiCr | 1/5 |

“/” in Table 1 indicates that the material on the left side is arranged under the material on the right side. In other word, material on the left side is formed prior to the material on the right side.

Ten examples of the MR element were prepared which differ in the kind of material of Heusler alloy that is contained in the inner layer, the material of the compounds, and the forming method (Examples 1-1 to 1-10). A comparative example having no compounds (Comparative Example 1-1), and a comparative example having no Heusler alloy in the inner layer (Comparative Example 1-2) were also prepared for comparison. In the examples having compounds, the compounds were oxides. The junction size of each sample was 0.2 μm×0.2 μm.

Table 2 shows the material of Heusler alloy, the composition ratio after deposition, the material of the oxide, the forming method of the oxide, the MR ratio, and resistance-area RA for each sample.

TABLE 2

| | Inner layer | | | | Compounds | | | |
|---|---|---|---|---|---|---|---|---|
| | | Composition | | | Forming | | MR ratio | RA |
| Sample | Material | Co | Y | Z | Method | Material | (%) | (Ω · μm²) |
| Example 1-1 | CoMnSi | 50 | 25 | 25 | Method 1 | SiOx | 8.0 | 0.09 |
| Example 1-2 | CoMnSi | 50 | 25 | 25 | Method 1 | MnOx | 7.5 | 0.10 |
| Example 1-3 | CoMnSi | 48 | 23 | 29 | Method 2 | SiOx | 7.7 | 0.09 |
| Example 1-4 | CoMnSi | 47 | 30 | 23 | Method 2 | MnOx | 7.3 | 0.11 |
| Example 1-5 | CoMnAl | 50 | 25 | 25 | Method 1 | AlOx | 6.1 | 0.10 |
| Example 1-6 | CoMnAl | 50 | 25 | 25 | Method 1 | MnOx | 7.2 | 0.10 |
| Example 1-7 | CoMnAl | 46 | 23 | 31 | Method 2 | AlOx | 5.8 | 0.12 |
| Example 1-8 | CoMnAl | 46 | 29 | 25 | Method 2 | MnOx | 6.9 | 0.11 |
| Example 1-9 | Co(Cr_{0.6}Fe_{0.4})Al | 50 | 25 | 25 | Method 1 | SiOx | 6.2 | 0.08 |
| Example 1-10 | Co(Cr_{0.6}Fe_{0.4})Si | 50 | 25 | 25 | Method 1 | CrOx | 6.8 | 0.08 |
| Comp. Ex. 1-1 | CoMnSi | 50 | 25 | 25 | — | — | 4.5 | 0.07 |
| Comp. Ex. 1-2 | (CoFe only) | — | — | — | — | — | 3.5 | 0.06 |

(Note)
Comp. Ex.: Comparative Example

In Table 2, “Method 1” shown in the column “Forming Method” under “Compounds” includes depositing raw material on a layer on which the compounds are to be formed, and oxidizing the raw material that has been deposited (see “the first method” that is described in relation to the layer structure shown in FIG. 2). “Method 2” includes forming a Heusler alloy layer having a composition that deviates from the stoichiometric composition, and exposing the surface of the Heusler alloy layer to an oxidizing atmosphere (see “the second method” that is described in relation to the layer structure shown in FIG. 2).

Referring to Table 2, it is found that by comparing Comparative Example 1-1 and 1-2, Comparative Example 1-1 has a larger MR ratio than Comparative Example 1-2. This shows that the MR ratio is improved by forming the portion of the inner layer by using Heusler alloy that is adjacent to the spacer layer. Further, from the comparison between Comparative Example 1-1 and Examples 1-1 to 1-10, it is found that the MR ratio is further improved by forming compounds at the interface between the inner layer and the spacer layer. In particular, the MR ratio was improved by 65% or more for examples having the same material (CoMnSi) for the Heusler alloy. On the other hand, there was not much difference in RA between examples having the compounds (Examples 1-1 to 1-10) and examples having no compounds (Comparative Example 1-1, 1-2). This means that the compounds do not cause a substantial increase in RA, and that the high-frequency response can be sufficiently maintained.

### EXAMPLE 2

In Example 2, the MR element shown in FIG. 4 was manufactured. Table 3 shows the layer structure and the thickness of each layer.

TABLE 3

| | | Material | Thickness (nm) |
|---|---|---|---|
| Cap layer | | Ru | 10 |
| Free layer | | Heusler alloy/CoFe | 2/2 |
| Compounds | | (oxide) | — |
| Spacer layer | | Cu | 3 |
| Pinned layer | Inner layer | CoFe/Heusler alloy | 1/3 |
| | Intermediate layer | Ru | 0.8 |
| | Outer layer | CoFe/FeCo/CoFe | 0.5/0.5/1 |

| | | |
|---|---|---|
| Antiferromagnetic layer | IrMn | 7 |
| Buffer layer | Ta/NiCr | 1/5 |

“/” in Table 3 has the same meaning as in Table 1.

Eight examples of the MR element were prepared which differ in the kind of materials of Heusler alloy that is contained in the inner layer and the free layer, material of the compounds, and the forming methods (Examples 2-1 to 2-8). A comparative example having no compounds (Comparative Example 2-1), and a comparative example having no Heusler alloy in the free layer (Comparative Example 2-2) were also prepared for comparison. In the examples having compounds, the compounds were oxides. The junction size of each sample was 0.2μm×0.2μm.

Table 4 shows the material of Heusler alloy (in the free layer only), the composition ratio after deposition, the material of the oxide, the forming method of the oxide, the MR ratio, and resistance-area RA for each sample.

TABLE 4

| | Inner layer | | | | Compounds | | | |
|---|---|---|---|---|---|---|---|---|
| | | Composition | | | Forming | | MR ratio | RA |
| Sample | Material | Co | Y | Z | Method | Material | (%) | (Ω · μm²) |
| Example 2-1 | CoMnSi | 50 | 25 | 25 | Method 1 | SiOx | 7.1 | 0.11 |
| Example 2-2 | CoMnSi | 50 | 25 | 25 | Method 1 | MnOx | 6.5 | 0.10 |
| Example 2-3 | CoMnSi | 48 | 25 | 27 | Method 2 | SiOx | 6.8 | 0.10 |
| Example 2-4 | CoMnSi | 48 | 28 | 24 | Method 2 | MnOx | 6.3 | 0.09 |
| Example 2-5 | CoMnAl | 50 | 25 | 25 | Method 1 | AlOx | 5.7 | 0.08 |
| Example 2-6 | CoMnAl | 48 | 25 | 27 | Method 2 | MnOx | 5.4 | 0.09 |
| Example 2-7 | Co(Cr_{0.6}Fe_{0.4})Al | 50 | 25 | 25 | Method 1 | SiOx | 5.4 | 0.10 |
| Example 2-8 | Co(Cr_{0.6}Fe_{0.4})Si | 50 | 25 | 25 | Method 1 | CrOx | 5.9 | 0.11 |
| Comp. Ex. 2-1 | CoMnSi | 50 | 25 | 25 | — | — | 3.9 | 0.06 |
| Comp. Ex. 2-2 | (CoFe only) | — | — | — | — | — | 2.8 | 0.06 |

(Note)
Comp. Ex.: Comparative Example

In Table 4, “Method 1” shown in the column “Forming Method” under “Compounds” includes depositing raw material on a layer on which the compounds are to be formed and oxidizing the raw material that has been deposited (see “the first method” that is described in relation to the layer structure shown in FIG. 4). “Method 2” includes making the spacer layer adsorb oxygen to the surface thereof, and forming a Heusler alloy layer having a composition that deviates from the stoichiometric composition on the surface of the spacer layer (see “the second method” that is described in relation to the layer structure shown in FIG. 4).

Referring to Table 4, it is found that by-comparing Comparative Example 2-1 and 2-2, Comparative Example 2-1 has a larger MR ratio than Comparative Example 2-2. This shows that the MR ratio is improved by forming the portion of the free layer in the Heusler alloy that is adjacent to the spacer layer. Further, from a comparison between Comparative Example 2-1 and Examples 2-1 to 2-8, it is found that the MR ratio is further improved by forming compounds at the interface between the free layer and the spacer layer. In particular, the MR ratio was improved by 60% or more for the examples having the same material (CoMnSi) for the Heusler alloy. On the other hand, there was not much difference in RA between the examples having compounds (Examples 2-1 to 2-8) and the examples having no compounds (Comparative Example 2-1, 2-2). This means that the compounds do not cause a substantial increase in RA, and that the high-frequency response can be sufficiently kept.

Although a certain preferred embodiments of the present invention have been shown and described in detail, it should be understood that various changes and modifications may be made without departing from the spirit or scope of the appended claims.

What is claimed is:

1. A magneto-resistance effect element comprising:
a pinned layer whose magnetization direction is fixed;
a free layer whose magnetization direction varies in accordance with an external magnetic field; and
a nonmagnetic spacer layer that is arranged between said pinned layer and said free layer:
wherein at least either said pinned layer or said free layer includes a Heusler alloy layer that is disposed adjacent to said spacer layer, and
wherein compounds are arranged in a dotted pattern at an interface between at least said spacer layer and said pinned layer or said spacer layer and said free layer, said compounds including material that is included in said Heusler alloy layer.

2. The magneto-resistance effect element according to claim 1, wherein said compound is an oxide.

3. The magneto-resistance effect element according to claim 1, wherein said Heusler alloy layer is made of full-Heusler alloy, said full-Heusler alloy being represented by a chemical formula X₂YZ,
wherein X is at least one element that is selected from the group consisting of Co, Ir, Rh, Pt, and Cu,
wherein Y is at least one element that is selected from the group consisting of V, Cr, Mn, and Fe, and
wherein Z is at least one element that is selected from the group consisting of Al, Si, Ga, Sb, and Ge.

4. The magneto-resistance effect element according to claim 1, wherein said Heusler alloy layer is made of Heusler alloy, said Heusler alloy being represented by a chemical formula XYZ,
wherein X is at least one element that is selected from the group consisting of Co, Ir, Rh, Pt, and Cu,
wherein Y is at least one element that is selected from the group consisting of V, Cr, Mn, and Fe, and
wherein Z is at least one element that is selected from the group consisting of Al, Si, Ga, Sb, and Ge.

5. The magneto-resistance effect element according to claim 1, wherein said compound is an oxide of Cr, Mn, Al, or Si.

6. The magneto-resistance effect element according to claim 1, wherein said pinned layer includes a nonmagnetic intermediate layer and two ferromagnetic layers that sandwich said nonmagnetic intermediate layer.

7. The magneto-resistance effect element according to claim 1, wherein a ratio of a total area of said compounds to a total area of said interface is less than 50%.

8. A thin film magnetic head comprising the magneto-resistance effect element according to claim 1.

9. A method of manufacturing a magneto-resistance effect element in which a pinned layer whose magnetization direction is fixed, a nonmagnetic spacer layer, and a free layer whose magnetization direction varies in accordance with an external magnetic field are stacked in this order, said method comprising:
a step of forming a Heusler alloy layer in at least either said pinned layer or said free layer such that said Heusler alloy layer is disposed adjacent to said spacer layer; and
a step of forming compounds in a dotted pattern at an interface between at least said spacer layer and one of said Heusler alloy layers, said compounds including material that is included in said Heusler alloy layer.

10. The method according to claim 9,
wherein the step of forming the Heusler alloy layer includes forming at least a surface of said pinned layer in Heusler alloy, and
wherein the step of forming compounds includes depositing raw material on a surface of said Heusler alloy layer, and oxidizing or nitriding said raw material, wherein said raw material is made of material that is included in said Heusler alloy layer.

11. The method according to claim 9,
wherein the step of forming the Heusler alloy layer includes forming at least a surface of said pinned layer in Heusler alloy, said Heusler alloy having a composition that deviates from a stoichiometric composition, and
wherein the step of forming compounds oxidizing or nitriding a surface of said Heusler alloy layer.

12. The method according to claim 9,
wherein the step of forming the Heusler alloy layer includes forming at least a surface of said free layer in Heusler alloy, the surface facing said spacer layer, and
wherein the step of forming compounds includes depositing raw material on a surface of said spacer layer, and oxidizing or nitriding said raw material, wherein said raw material is made of material that is included in said Heusler alloy layer.

13. The method according to claim 9,
wherein the step of forming the Heusler alloy layer includes making said spacer layer adsorb oxygen or nitrogen on a surface of said spacer layer and the step of forming compounds, and
wherein the step of forming compounds includes forming said Heusler alloy layer on a surface of said spacer layer that adsorbs said oxygen or nitrogen such that a part or an entire part of said free layer has a composition that deviates from a stoichiometric composition.
